(19) United States
(12) Patent Application Publication
(10) Pub. No.: US 2009/0013481 A1
(43) Pub. Date: Jan. 15, 2009

(54) COMPOSITION TO IMPART BENEFIT AGENTS TO ANIONIC SUBSTRATES AND METHODS OF ITS USE

(76) Inventors: Allwyn Colaco, South River, NJ (US); Joel Coret, Princeton, NJ (US); Saurabh Desai, Somerset, NJ (US); Shailendra Singh, Monroe, NJ (US); Robert Bianchini, Hillsborough, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/777,068

(22) Filed: Jul. 12, 2007

(51) Int. Cl. A61Q 1/00; A61Q 3/02; A61Q 5/10

(52) U.S. Cl. 8/426; 8/554; 8/561; 8/606

(57) ABSTRACT

This invention relates to compositions containing pigments or other benefit agents in particulate form may be combined with a quaternary ammonium compound that can effectuate adsorption to anionic substrates, methods of making such compositions and methods of their use.

### FIELD OF THE INVENTION

This invention relates to compositions capable of aiding the deposition of benefit agents, preferably hair benefit agents, on anionic substrates, including keratin-containing substrates such as hair, skin and nails and methods of their use such that such deposition is resistant to exposure to surfactants or cleansing agents. Hair benefit agents include pigments, colorants and conditioning agents. Keratin-containing substrates also include wool, for example.

### BACKGROUND OF THE INVENTION

For many years, individuals with graying or fading hair colors have sought the use of permanent or semi-permanent dyes to change the color of their hair. Such dyes generally operate under the oxidative and direct dyeing processes and cause substantial damage to the hair of individuals utilizing such dyes. For example, in order to permit the dye to penetrate into the hair to effect a color change, the individual must cause the cuticle of the hair to open, usually by oxidizing the hair. This process causes great damage to the hair cuticle, drying the hair, which can result in hair breakage and lend an unhealthy appearance and texture to the hair. However, this process has come to be the most acceptable means of achieving desired shades and colors in hair, despite these disadvantages.

Pigment, defined as a “fine insoluble white, black, or colored material” [Julius Grant, editor, Hackh's Chemical Dictionary, McGraw-Hill Book Company, New York, 1969], has also been utilized to change the color of substrates. However, pigments are rarely used in hair coloring due to the complexities of applying and retaining the pigment on hair. The geometry of pigment particles, their size, index of refraction, surface properties are among the characteristics of pigments that make them difficult to use in hair coloring processes.

While pigments are used primarily in mascara, they are present in very high loadings, on the order of 10 to 30 weight percent. Furthermore, pigments need to be held in place using film-forming polymers or other styling polymers. These compositions must coat the hair and adhere the pigments to the hair surface. These mechanical bonds are fairly loose and thus such pigment compositions are quite easy to remove. Coating longer hairs with polymers may also cause the hairs' texture and appearance to become unnatural and result in difficulty in managing the hair.

In addition, pigments are difficult to use in cosmetic applications that require detergents, conditioning agents, thickeners, silicones, solvents, inorganic and organic salts, humectants and other typical cosmetic ingredients. This is due both to pigments' tendency to deposit competitively on hair substrates, causing other hair benefit agents to fail to deposit and bond with the substrates; as well as their lack of compatibility with such materials in formulations. Thus, formulations containing pigments may lack several desirable consumer benefits.

Furthermore, due to their insoluble nature, pigment-containing formulations are generally difficult to stabilize. The pigments must be suspended in the compositions so as not to precipitate in an esthetically undesirable manner.

However, heretofore, there has not been means for affecting keratin fiber color by sustainably attaching pigments to the keratin fibers such that the color is resistant to being washed off or otherwise easily removed.

### SUMMARY OF THE INVENTION

Surprisingly, we have found that compositions containing pigments or other benefit agents in particulate form may be combined with a quaternary ammonium compound according to Formula (I) that can effectuate adsorption to anionic substrates:

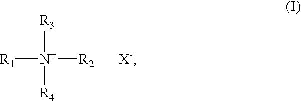

wherein

R₁, R₂, and R₃ are straight or branched carbon chains that may be alkyl or alkenyl groups having from about 8 to about 36 carbon atoms and R₄ is a lower alkyl chain having from about 1 to about 4 carbon atoms or a lower alcohol having from about 1 to about 4 carbon atoms.

R₁ and R₂ may both be identical or different straight or branched alkyl or alkenyl chains having from about 8 to about 36 carbon atoms, and R₃ and R₄, independently of one another, may be identical or different and are lower alkyl chain having from about 1 to about 4 carbon atoms or a lower alcohol having from about 1 to about 4 carbon atoms; and

X— is an anion selected from the group consisting of monoatomic anions (for example halogens) and oxoanions. Examples of monoatomic anions include chloride, bromide, fluoride, oxide, and nitride. Examples of oxoanions include hydroxide, carbonate, bicarbonate, phosphates, phosphites, hypophosphite, nitrates, sulfates, borates, hypochlorite, chlorite, chlorate, methosulfate, hydrogensulfate, lactate, citrate, and mixtures thereof.

The pigments and particulates useful in the compositions and methods of this invention may be coated with a polymer that enhances the electrostatic and hydrophobic characteristics of the particulates and/or pigments. For example, polymethylmethacrylate may be used to enhance the electrostatic and hydrophobic characteristics of the pigments and particulates of the compositions of this invention. Other useful polymers include, but are not limited to: lipophilic polymer materials

Such materials may be unexpectedly sustainably attached to particles such as pigments or other benefit agents so as to permit their adherence to or combination with keratin-containing materials.

Without wishing to be bound by the following theory, we have also unexpectedly found that the sustainable attachment between such benefit agents and anionic substrates is achieved through a combination of surface charge and lipophilic effect. The surface of untreated anionic materials is generally negative, thus cationic compounds tend to be attracted to anionic materials. However, surface charge does not provide sufficient attraction to bind a particle to the anionic material. We have surprisingly found that cationic compounds that have lipophilic solubility in addition to high electrostatic affinity for keratin-containing materials are able to achieve sustainable binding force between anionic material and benefit agents.

### DESCRIPTION OF THE DRAWINGS

FIG. 1 is a graph illustrating the influence of cationic surfactants and polymers on uptake of pigment for bleached and natural blond hair.

### DETAILED DESCRIPTION OF PREFERRED EMBODIMENTS

For the purpose of this invention, the term “benefit agent” means an agent that can affect the appearance and/or texture of a keratin-containing substrate.

For the purpose of this invention, the term “anionic substrate” includes any negatively-charged substrate to which one desires to adhere or adsorb a benefit agent.

For the purpose of this invention, the term “keratin-containing substrate” includes hair, skin, teeth, nails, wool, fur, and any other material that contains keratin.

For the purpose of this invention, the term “particle” means a small, discrete portion of material that has mass and dimension.

For the purpose of this invention, the term “pigment” is a fine insoluble white, black or colored material.

We have found that, unexpectedly, in order to bind particulate or other benefit agents to a substrate containing keratin or other substrate having a negative charge (i.e., anionic substrate), a such benefit agent should be combined with a material that has both an electrostatic force that is strongly attracted to the substrate as well as a hydrophilic-lipophilic balance characteristic (hereinafter, “HLB”) that is sufficiently lipophilic to provide sustainable attachment between the benefit agent and the substrate. More particularly, for the case in which said benefit agent has no charge, the benefit agent will not be attracted to or bind with a charged substrate without association with some additional ingredient. Addition of a hydrophobic material in association with said benefit agent maximizes the hydrophobic interaction between the hydrocarbon chains and hydrophobic sites on the particle. Such a hydrophobic material is attracted to the surface of a substrate, in particular a keratin-containing substrate and creates an initial binding. Preferably, the HLB, or water solubility, of the quaternary ammonium compound is low, preferably below 10. For example Tricetyl ammonium chloride (commercially available as Arquad 316 from Akzo Nobel of Arnhem, the Netherlands) has an HLB of 7.6 and is water dispersible.

However, we have found that such initial binding is not sustainable over a long period of time unless the benefit agent/hydrophobic material complex also has associated with it a strong electrostatic charge, which is measured by “zeta potential”. Zeta potential is measured using a Malvern zetasizer. Zeta potential is the difference in potential between the immovable layer attached to the surface of the dispersed phase and the dispersion medium. Furthermore, the magnitude of the zeta potential gives an indication of the potential stability of the colloidal system. To maintain the stability of the dispersion, all the particles in suspension must have a large negative or positive zeta potential so they will tend to repel each other and there will be no tendency for the particles to come together. Typically, aqueous colloidal systems are electronegative, with the general range of zeta potential being −14 to −30 millivolts. These systems have poor adhesion to anionic substrates like hair and skin. Therefore, altering the particulates' zeta potential will increase the substantivity to anionic substrates. For example, the zeta potential of red iron oxide at a pH of 7.5, controlled with tris buffer, is −30 mV. When 2% by weight tricetylammonium chloride is added to 2% red iron oxide, the charge of the layer surrounding the pigment is altered to +50 to +60 mV. This balance of zeta potential and HLB is illustrated in the compositions of this invention that contain a quaternary ammonium compound and particulate, making it effective for adhesion onto anionic substrates.

Preferably, the quaternary ammonium compounds useful in the compositions and methods of this invention are those according to Formula I in which R₁, and R₂, are straight or branched alkyl or alkenyl groups having from about 8 to about 22 carbon atoms. Preferably, R₃ and R₄ are CH₃.

More preferably, the quaternary ammonium compounds useful in the compositions and methods of this invention are those according to Formula I in which R₁, R₂, and R₃ are straight or branched alkyl or alkenyl groups having from about 12 to about 22 carbon atoms. Preferably, R₄ is CH₃. Most preferably, such alkyl or alkenyl groups should have from about 16 to about 22 carbon atoms.

More preferably, the quaternary ammonium compounds useful in the compositions and methods of this invention are: dicetyl dimethyl ammonium quat, dibehenyl dimethyl ammonium quat (both available commercially as Incroquat DCMC and Incroquat DBM-90 respectively from Croda Inc., 7 Century Drive, Parsippany, N.J. 07054). Most preferably, the quaternary ammonium compounds useful in the compositions and methods of this invention are tricetyl methylammonium methoxysulfate and tricetyl methylammonium chloride (available commercially as Arquad 316 from Akzo Nobel of Arnhem, the Netherlands) Preferably, the anion associate with the quaternary ammonium compounds useful in the compositions and methods of this invention is chloride, bromide, and methoxysulfate as these ingredients are commonly used in cosmetic products.

Preferably, the quaternary ammonium compounds useful in the compositions and methods of this invention are physically adsorbed onto benefit agents. The coated benefit agents may then be combined with a substrate so as to permit the coated benefit agents to adhere to the substrate and impart a benefit.

The quaternary ammonium compounds useful in the compositions and methods of this invention should be capable of complexing with anionic compounds that can be benefit agents in order to adhere to keratin-containing substrates such as hair. Examples of such anionic compounds include acrylates, sulfates, sulfonates, sufosuccinate, phosphate and phosphonates and the like. Such anionic compounds may be present in the form of surfactants, polymers, salts, acids, bases AND THE LIKE. They can be useful as coloring agents, conditioners, shampoos, body cleansers and other soap-like products.

One type of benefit agent that may be used in combination with the quaternary ammonium compounds set forth above in compositions and methods of this invention is pigment.

Pigments or micropigments, particularly metal compounds or semimetallic compounds may be used in the compositions and methods of this invention in ionic, nonionic or oxidized form. The pigments can be in this form either individually or in admixture or as individual mixed oxides or mixtures thereof, including mixtures of mixed oxides and pure oxides. Examples are the titanium oxides (for example TiO₂), zinc oxides (for example ZnO), aluminum oxides (for example Al₂O₃), iron oxides (for example Fe₂O₃), manganese oxides (for example MnO), silicon oxides (for example SiO₂), silicates, cerium oxide, zirconium oxides (for example ZrO₂), barium sulfate (BaSO₄) or mixtures thereof. Suitable pigments or micropigments are commercially available. An example is Hombitec® L5 (INCI name: titanium dioxides) supplied by Merck.

Other examples of pigments include the following: D&C Red No. 36, D&C Red No. 30, D&C Orange No. 17, Green 3 Lake, Ext. Yellow 7 Lake, Orange 4 Lake, Red 28 Lake, the calcium lakes of D&C Red Nos. 7, 11, 31 and 34, the barium lake of D&C Red No. 12, the strontium lake D&C Red No. 13, the aluminum lakes of FD&C Yellow No. 5 and No. 6, the aluminum lakes of FD&C No. 40, the aluminum lakes of D&C Red Nos. 21, 22, 27, and 28, the aluminum lakes of FD&C Blue No. 1, the aluminum lakes of D&C Orange No. 5, the aluminum lakes of D&C Yellow No. 10; the zirconium lake of D&C Red No. 33, Cromophthal® Yellow, Sunfast® Magenta, Sunfast® Blue, iron oxides, calcium carbonate, aluminum hydroxide, calcium sulfate, kaolin, ferric ammonium ferrocyanide, magnesium carbonate, carmine, barium sulfate, mica, bismuth oxychloride, zinc stearate, manganese violet, chromium oxide, titanium dioxide, titanium dioxide nanoparticles, zinc oxide, barium oxide, ultramarine blue, bismuth citrate, hydroxyapatite, zirconium silicate, carbon black particles and the like.

Benefit agents may include particles other than pigments, such as pharmaceuticals in the form of particulates that may be applied topically, including antimicrobials such as microbiologically active component selected from the group consisting of quaternary ammonium compounds, monoquaternary heterocyclic amine salts, urea derivatives, amino compounds, imidazole derivatives, nitrile compounds, tin compounds or complexes, isothiazolin-3-ones, thiazole derivatives, nitro compounds, iodine compounds, aldehyde release agents, thiones, triazine derivatives, oxazolidine and derivatives thereof, furan and derivatives thereof, carboxylic acids and the salts and esters thereof, phenol and derivatives thereof, sulphone derivatives, imides, thioamides, 2-mercapto-pyridine-N-oxide, azole fungicides, strobilurins, amides, carbamates, pyridine derivatives, compounds with active halogen groups, and organometallic compounds including silver oxide particles, chromium oxide particles. Such materials may be adhered to a wound or damaged skin using the compositions and methods of this invention.

Benefit agents may also include pigment particles that provide mechanical sun blocking capability, including titanium dioxide, silicon oxide, zinc oxide and the like.

The compositions and methods of this invention may also contain spherical, hemispherical, and non-spherical synthetic particles as the benefit agent. Synthetic polymer beads range in size from about 0.1 to about 1000 μm and are commonly used in the cosmetic industry. Beads may be composed of polyacrylate, polystyrene, polymethyl methacrylate, nylon-12, and silicone, which can be homopolymers or copolymers. These polymers are preferably blended or cross-linked to produce smooth, porous, hollow, and oblong beads. The hydrophobic tails of the quaternary ammonium compounds useful in the compositions and methods of this invention are believed to be attracted to the hydrophobic surface of such beads. It is expected that this would greatly improve the dispersion of the beads in the formulation and the delivery of the beads to anionic substrates. Preferably, the particles include polymethylmethacrylate (PMMA), crosslinked PMMA and acrylates copolymer (available under the trade names GM-0600W, GMP-0800, and GMX-0410 from Ganz Chemical Co., LTD).

The compositions of this invention may be prepared in the form of formulations known to be useful for cosmetic skin and hair products. For example, they can be in the form of shampoos, conditioners, lotions, rinses, dispersions, emulsions, gels, cream gels, creams, pastes, sticks, lotions, suspensions, sprays, mousse, aerosols or foams. To the compositions of the invention may be added other substances, auxiliary agents, for example those commonly used for cosmetic products in general. Such materials include, for example, thickeners (for example clays, starches, polyacrylic acid and the derivatives thereof), cellulose derivatives lanolin derivatives, vitamins or provitamins, (for example biotin, vitamin C, tocopherols or D-panthenol), antigrease agents, inorganic or organic acids (for example lactic acid, citric acid, glycolic acid or phosphoric acid), preservatives (for example para-hydroxybenzoate esters), nonaqueous solvents, antioxidants (for example tocopherols or the esters thereof), dyes and fragrances or perfumes, UV light-absorbing inorganic particles and others known to those of ordinary skill in the art.

The compositions of this invention may be utilized in any types of products that impart benefit agents to substrates, including, but not limited to the following: wrinkle-diminishing topical products for skin, hair color, antiperspirants, powders, make-up, soap bars, mascara, foundations, lip color, blush, cosmetic pencils, sunscreens and sun protectants, topical antimicrobial products, topical antibiotics, topical fungicides, fabric coloring and the like.

Substrates to which the compositions of this invention may be applied to which color may be imparted include hair, skin, teeth, nails, wool, cotton, rayon, nonwoven polymeric fabrics, sutures and the like. Preferably, the substrates should have a negative electrostatic charge.

In some instances, it may be preferable to provide a coating to the particulate benefit agents useful in the compositions of this invention in order to increase the hydrophobicity of the benefit agent. If utilized, such coatings should be composed of a hydrophobic (also described as “lipophilic”) material that can readily reside upon the benefit agent useful in the compositions of this invention. The concentration of coating can range up to about 50 percent by weight of the compositions of this invention. More preferably, the coating will compose up to about 5% by weight. Such coatings may be composed of one or more lipophilic compounds such as methicone, dimethicone, triethoxycaprylylsilane, isopropyl titanium triisostearate, triethoxysilane, as well as crosspolymers of the mentioned coatings and the like. Suitable examples of isopropyl titanium triisostearate particles include iron oxide and polymethylmethacrylate marketed by Kobo Inc under the trade names BBO-12 and BPA-515 respectively. In the alternative, such coatings may be composed of a lipophilic polymer material, including, but not limited to styrene, acrylates, PMMA and the like. Coatings that are not generally lipophilic, including polysaccharide, cellulose, chitosan, lauroyl lysine, and PEG-8 methyl ether and the like, may be useful in that they associate with the quaternary ammonium compounds useful in the compositions of this invention and may be utilized to improve the cosmetic and formulary characteristics of the compositions of this invention. Such coatings may be applied to the benefit agents using known extrusion and coating processes or the like.

In order to make the compositions of this invention, the cationic quaternary ammonium compounds useful in the compositions should be combined with the benefit agents and sufficient energy applied to the combination to form a homogeneous mixture by dispersing the benefit agent uniformly with the cationic quaternary ammonium compound. Such energy may be applied through physical mixing, cavitation with microwaves, heat, ultrasound, and the like. This mixture should then be combined with the desired colorants and then applied to the substrate in order to impart color to the substrate.

The steps for preparing the compositions of the invention may include, but are not limited to the following:

Pigment dispersion preparation (side phase): quaternary ammonium compound is charged to a vessel (for example Tricetyl Methyl Ammonium Chloride) and heated to a temperature of from about 40° C. to about 60° C. A particulate benefit agent such as a pigment (for example, iron oxide), wetting agent/solvent may be optionally added (for example, benzyl alcohol), and silicone may be optionally added (for example, Dimethicone) are then preferably added to the quaternary ammonium compound and dispersed with a homogenizer (for example, a Silverson L4RT) until uniform. The dispersion quality is then measured with a Hegman grind gauge. The Hegman grind gauge measures the particle size of the pigments in the dispersion. During the mixing operation, small quantities may be taken on a spatula and spread on a Hegman grind gauge. If the dispersion is smooth, lacking coarse particles, and of approximately the same range of particle size of the pigments, the process may be continued with the preparation of the main phase. For example, if one-micron iron oxide pigments are used in the dispersion, then the dispersion quality should be smooth up to one micron. If not, the homogenization process should be continued.

Aqueous phase preparation (Main phase): Water should be heated in another vessel separate from that in which the side phase is prepared. The water should be heated to from about 55° C. to about 60° C. Thickener (for example Hydroxyethylcellulose) may optionally be added to the water and mixing continued until the mixture is uniform. The mixture should then be heated up to 75-80° C.

Oil phase preparation (side phase): A fatty alcohol compound (for example cetyl alcohol) may then be added to another vessel, emulsifier (for example ceteareth-20), and opacifier (for example glycol distearate) and the mixture heated to a temperature of up to about 75-80° C. The oil phase should then be mixed until the mixture is substantially uniform.

The oil phase should be added into the water phase (oil in water emulsion) and mixed at about 75 to about 80° C. at a moderate to high rate (500-1000 rpm) and mixing continued for approximately 30 minutes The emulsion can be analyzed for smoothness by spreading a sample on a spatula. If there are clumps, grains, or excess of one phase, mixing should be continued for about ten additional minutes. The quality of an emulsion can also be analyzed under a microscope. The batch should then be cooled to about 55 to about 60° C.

The pigment dispersion phase should then be added to the mixture at a temperature of about 55 to about 60° C. and mixed at the same rate for 20 minutes. The dispersion quality is then measured with a Hegman grind gauge.

The batch should then be cooled to a temperature of about 35-40 C and preservative may be added (for example DMDM Hydantoin). The batch may then be cooled to room temperature, fragrance added and the batch mixed at a lower rate (for example 200-300 rpm) until it is uniform.

### Additional Conditioning Agents

Additional agents may be provided in the compositions of this invention to impart improved characteristics to the substrates being dyed. These can include conditioning agents that improve the appearance, texture, and sheen of the substrate as well as increasing the substrate's body or suppleness. While the conditioning agents mentioned below relate to hair conditioning, such agents may also be utilized when dyeing fabric, nails, or other substrates to improve texture and appearance of the substrate.

Non-ionic conditioning agents can be included in the coloring composition to facilitate the composition formulation and enhance consumer appeal. The preferred hair conditioning agents of the present invention are those that are nonionic. Suitable examples of hair conditioning agents include, but are not limited to, nonionic fatty alcohols; nonionic fatty amines; nonionic waxes; nonionic esters; nonionic polymers, such as polyvinylpyrrolidone, polyvinyl alcohol, and polyethylene glycol; nonionic silicones; nonionic siloxanes; and nonionic polymer emulsions. Examples of preferred additional conditioning agents are non-ionic silicone conditioning agent, surfactant non-ionic conditioning agents, or the mixtures thereof. Examples of non-ionic silicone conditioning agents are, but not limited to, dimethyl polysiloxane, methylphenyl polysiloxane, amino-modified silicones, and alkyl-modified silicones, and the mixtures thereof.

Surfactant non-ionic conditioning agents include, but not limited to, stearylamidopropyl dimethylamine, isostearamidopropyl dimethylamine, oleamidopropyl dimethylamine, behenaamidopropyl dimethylamine, brassicamidopropyl dimethylamine, didecylmethylamine oxide, stearyldimethylamine oxide, and the mixtures thereof. The non-ionic silicone conditioning agents include, but not limited to, dimethyl polysiloxane, methylphenyl polysiloxane, amino-modified silicones, and alkyl-modified silicones, and the mixtures thereof.

### Additional Quaternary Ammonium Compounds

Other optional ingredients may be included in the compositions of this invention to enhance the deposition of the benefit agents of the composition. For example, quaternary ammonium compounds other than those set forth above may be included in the conditioning composition. Quaternary ammonium compounds useful in the composition of the present invention preferably include, but not limited to, a water-soluble quaternary ammonium compound having one or two long chain alkyl groups containing from about 8 to about 18 carbon atoms. The long chain alkyl groups also may include, in addition to, or as a substitute for, carbon and hydrogen atoms, ether linkages or similar water-solubilizing linkages. The remaining two to three substituents of the quaternary nitrogen of the quaternary ammonium compound can be hydrogen, benzyl groups, short chain alkyl or hydroxyalkyl groups such as methyl, ethyl, hydroxymethyl or hydroxyethyl groups or mixtures thereof. In addition, an oil-soluble, water dispersible quaternary ammonium compound, either alone or in combination with a water-soluble quaternary ammonium compound, may also be used in the composition of the present invention.

### Other Cosmetic Components and Additives

In addition to the above-described ingredients, other common cosmetic components and additives may be incorporated in the compositions of this invention, as long as the basic properties of the composition, and an ability to color substrates are preserved. Such ingredients include, but are not limited to, humectants, emollients, moisturizers, inorganic salts, fragrances, dyes, hair colorants, hydrotropes, foam stabilizers, preservatives, water softening agents, acids, bases, buffers and the like. Optional components may be present in weight percentages of less than about 2% each, and from about 5% to about 10% by weight of the composition in total.

### Optional Thickeners

An optional ionic thickener may also be included in the compositions of this invention to improve composition esthetics and facilitate application of the composition to the substrate being dyed. Nonionic thickeners in an amount of up to about 3% by weight are preferred. Exemplary thickeners include, but are not limited to, celluloses or celluloses derivatives, guar gum or guar gum derivatives, polysaccharides, acrylamides copolymer, acrylates/behenth-25, methacrylate copolymer, acrylates C10 30 alkyl acrylate crosspolymer, acrylates ceteth-20 itaconate copolymer, acrylates/steareth-50 acrylate copolymer, acrylates/stearyl methacrylate copolymer, acrylates/vinyl isodecanoate crosspolymer, and the mixtures thereof.

### Cosmetically Acceptable Carriers:

The compositions of this invention should preferably contain a one or more cosmetically-acceptable carriers. Preferably, such carriers include water. Organic solvents may also be included in order to facilitate manufacturing of the composition or to provide esthetic properties, such as viscosity control. Suitable solvents include the lower alcohols like ethyl alcohol and isopropyl alcohol; glycol ethers, like 2-butoxyethanol, ethylene glycol monoethyl ether, propylene glycol and diethylene glycol monoethyl ether or monomethyl ether; and mixtures thereof. Non-aqueous solvents may be present in the conditioning composition of the present invention in an amount of about 1% to about 50%, and in particular about 5% to about 25%, by weight of the total weight of the carrier in the composition.

The compositions of this invention should be stable to phase or ingredient separation at a temperature of about 25° C. for an indefinite period of time, or at least for 5 weeks at a temperature of 45° C. Thus, the compositions of this invention have demonstrated sufficient stability to phase and ingredient separation at temperatures normally found in commercial product storage and shipping to remain unaffected for periods of at least one year.

This invention also relates to methods of using the compositions of this invention to dye substrates, including hair. Although the following recites hair as the substrate to be colored or to which a benefit agent may be adsorbed, the method described herein may be applied to other substrates that are amenable to treatment with the compositions of this invention. Treating the hair with the compositions of this invention is generally carried out by: (1) applying to dry or wet hair an effective amount of the composition of the invention; (2) distributing the composition of this invention more or less evenly throughout the hair such that it contacts all the hair or other substrate which is intended to be colored. This permits the benefit agents of the compositions of this invention to be applied thoroughly and evenly throughout the hair or other substrate. This step may be accomplished by rubbing the composition throughout the hair manually or using a hair appliance such as a comb for up to about 20 minutes; and (3) rinsing said hair or other substrate so as to remove excess material that has not penetrated into the hair with water. Treating the hair with the compositions of the invention may also be carried out by applying leave-on types of compositions, such as hair spray, cream, or solution, directly to hair without rinsing the hair.

The compositions and methods of this invention are further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### EXAMPLE 1

### Deposition of Color on Hair Using Cationic Quaternary Ammonium Compounds

Six compositions containing cationic molecules and coated pigments were combined with hair and measured in order to determine whether they deposited color on natural blond or bleached blond hair. Each composition contained 0.3% PMMA (Poly(methyl Methacrylate))-coated Iron Oxide pigment, 10 ml 0.05M phosphate buffer and 0.05% of a cationic molecule. Composition 1 contained conditioning polymer Polyquaternium-6 (“PQ-6”). PQ-6 is a polymeric quaternary ammonium salt of dimethyl diallyl ammonium chloride, which is available commercially as Merquat 100 from Nalco Company, 1601 W. Diehl Road, Naperville Ill. 60563. Composition 2 contained conditioning polymer PQ7 or Polyquaternium-7, which is the polymeric quaternary ammonium salt of acrylamide and dimethyl diallyl ammonium chloride, available commercially as Merquat 550 from Nalco Company, 1601 W. Diehl Road, Naperville Ill. 60563; Composition 3 contained conditioning polymer PQ-10, or Polyquaternium-10, which is a polymeric quaternary ammonium salt of hydroxyethyl cellulose reacted with a trimethyl ammonium substituted epoxide, which is available as Ucare Polymer JR-400 from Amerchol Corporation A subsidary of Dow Chemical Company, 171 River Road, Piscataway N.J. 08854; Composition 4 contained Arquad 316, Tricetylmonium Chloride available commercially from Akzo Nobel of Arnhem, the Netherlands; Composition 5 contained Varisoft 432, Dicetyldimonium Chloride available commercially from Akzo Nobel of Arnhem, the Netherlands; and Composition 6 contained Arquad S-50, Soytrimonium Chloride available commercially from Akzo Nobel of Arnhem, the Netherlands.

The compositions of this example were made as follows: 0.3% pigment (0.030 g) was dispersed in 10 ml of deionized water in a 20 ml vial and homogenized with an Ultra Turrax T-25 at a speed of 13,500 rpm for one minute.

A specified size tress of hair (0.5×15 cm) was then placed into the solution for 30 minutes under agitation by a platform agitator (DVX-2500) at 1500 rpm for 30 minutes.

The tresses were then removed and rinsed under controlled temperature (37-39 C) water. A blow dryer was then used to completely dry the tress.

The Compositions of this example were applied to two types of hair tresses one type that contained natural blond hair and another that contained bleached blond hair. Colorimetric measurements were performed using the Ultra ScanPro Spectrophotometer. Measurements were made according to the Hunter L,a,b Description as set forth in Table 1 below.

TABLE 1
Hunter L, a, b Description

| | (+) | (−) |
|---|---|---|
| L* (Lightness axis) | Lighter | Darker |
| a* (Red-Green axis) | Red | Green |
| b* (Blue-Yellow axis) | Blue | Yellow |

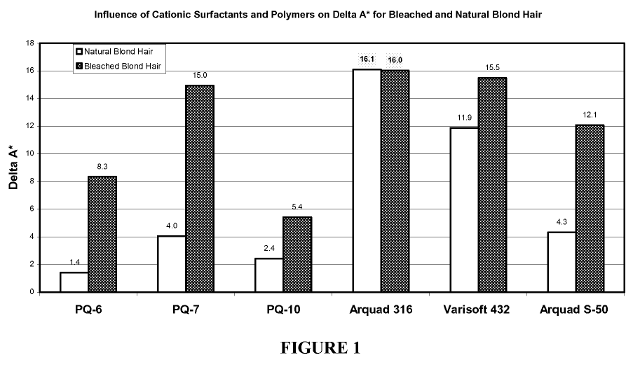

Because the PMMA-coated iron oxide is reddish in color, delta a* values were tabulated. The greater the a* value, the more reddish the color of the tress. As illustrated in FIG. 1, it can be seen that the cationic molecules that have more than one long-chain hydrophobic group result in a greater delta a* value, exhibiting a greater affinity for hair.

### EXAMPLE 2

### Hair Conditioning Materials

A base composition containing Arquad 316/PMMA coated pigment was made using the procedure set forth in Example 1. Certain ingredients commonly used in conditioning treatments for hair were added to the base composition to determine how they affected the ability of the composition to adsorb to hair and impart color to said hair. Ethylene glycol distearate may be used at a concentration of from about 0.25 to about 0.5% by weight to provide pearlescence to the formulation without affecting the color-imparting capability of the composition. Cetearyl alcohol may be used at a concentration of about 0.5% to provide viscosity and emulsion stability without negative effect. While about 0.5 to about 1% stearamidopropyl dimethylamine has a negative effect on the color deposition.

### EXAMPLE 3

### Solvent Effect on Coated Pigment

Addition of solvents to the base composition demonstrate a strong influence on pigment deposition on hair. Benzyl alcohol, phenoxy ethanol, and mineral oil all provided additional color to hair compared with the control composition.

The control composition contained, on a by weight basis, 0.5% hydroxyethylcellulose, 1.5% Arquad 316, and 0.3% PMMA (2%) coated red iron oxide. The addition of 3% mineral oil improved the delta a* by 3.7 compared to the control. Similarly the addition of 3% phenoxy ethanol or 3% benzyl alcohol increases the delta a* by 2.7 and 1.8 respectively compared with the control composition.

What is claimed is:

1. A composition for delivering a benefit agent to an anionic substrate, comprising:
a) a particulate benefit agent; and
b) a quaternary ammonium compound according to formula (1) 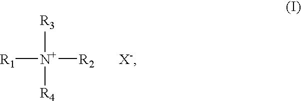
wherein
R₁, R₂, and R₃ are straight or branched carbon chains comprising alkyl or alkenyl groups having from about 8 to about 36 carbon atoms and R₄ is a lower alkyl chain having from about 1 to about 4 carbon atoms or a lower alcohol having from about 1 to about 4 carbon atoms.
R₁ and R₂ are identical or different straight or branched alkyl or alkenyl chains having from about 8 to about 36 carbon atoms, and R₃ and R₄, independently of one another, are identical or different and are lower alkyl chain having from about 1 to about 4 carbon atoms or a lower alcohol having from about 1 to about 4 carbon atoms; and
X— is an anion selected from the group consisting of halogens and oxo acids.

2. A composition according to claim 1 wherein R1 and R2 are identical alkyl or alkenyl chains having from about 8 to about 36 carbon atoms.

3. A composition according to claim 1 wherein R3 and R4 are identical and are lower alkyl chains having from about 1 to about 4 carbon atoms.

4. A composition according to claim 1 wherein R₁ and R₂ are different.

5. A composition according to claim 1 wherein X is a halogen selected from the group consisting of chloride, bromide, iodide and fluoride.

6. A composition according to claim 1 wherein X is an oxo acid selected from the group consisting of hydroxide, carbonate, bicarbonate, phosphate, phosphate, hypophosphite, nitrate, sulfate, borate, methosulfate, hydrogensulfate, lactate, citrate and mixtures thereof.

7. A composition according to claim 1 wherein said particulate benefit agent is a pigment.

8. A composition according to claim 7 wherein said pigment is a hair colorant.

9. A composition according to claim 8 wherein the pigment is selected from the group consisting of D&C Red No. 36, D&C Red No. 30, D&C Orange No. 17, Green 3 Lake, Ext. Yellow 7 Lake, Orange 4 Lake, Red 28 Lake, the calcium lakes of D&C Red Nos. 7, 11, 31 and 34, the barium lake of D&C Red No. 12, the strontium lake D&C Red No. 13, the aluminum lakes of FD&C Yellow No. 5 and No. 6, the aluminum lakes of FD&C No. 40, the aluminum lakes of D&C Red Nos. 21, 22, 27, and 28, the aluminum lakes of FD&C Blue No. 1, the aluminum lakes of D&C Orange No. 5, the aluminum lakes of D&C Yellow No. 10; the zirconium lake of D&C Red No. 33, Cromophthal® Yellow, Sunfast® Magenta, Sunfast® Blue, iron oxides, calcium carbonate, aluminum hydroxide, calcium sulfate, kaolin, ferric ammonium ferrocyanide, magnesium carbonate, carmine, barium sulfate, mica, bismuth oxychloride, zinc stearate, manganese violet, chromium oxide, titanium dioxide, titanium dioxide nanoparticles, zinc oxide, barium oxide, ultramarine blue, bismuth citrate, hydroxyapatite, zirconium silicate, and carbon black particles.

10. A composition according to claim 1 wherein the particulate benefit agent comprises colored polymer particles comprised of materials selected from the group consisting of polystyrene, polymethylmethacrylate, polyvinyltoluene, styrene/butadiene copolymer, and latex.

11. A composition according to claim 1 wherein said particulate benefit agent comprises particles having a coating.

12. A composition according to claim 11 wherein said coating is chemically bound to said particles.

13. A composition according to claim 12 wherein said of chemically bound coatings are selected from the group consisting of methicone, dimethicone, triethoxycaprylylsilane, isopropyl titanium triisostearate, acrylates, PEG-8 methyl ether triethoxysilane, crosspolymers thereof and mixtures thereof.

14. A composition according to claim 11 wherein said coating is physically bound to said particles.

15. A composition according to claim 14 wherein said physically bound coatings are selected from the group consisting of polymethylmethacrylate, polystyrene, polyvinyltoluene, polysaccharide, chitosan, styrene acrylates, lauroyl lysine, styrene/butadiene copolymer, crosspolymers thereof and mixtures thereof.

16. A composition according to claim 1, wherein said quaternary ammonium compounds are (C₈-C₃₆)-trialkyl quaternary ammonium compounds.

17. A composition in accordance with claim 16, wherein said trialkyl quaternary ammonium compound is tricetyl methylammonium chloride.

18. A composition in accordance with claim 1, wherein said quaternary ammonium compounds are (C₈-C₃₆)-dialkyl quaternary ammonium compounds.

19. A composition in accordance with claim 18, wherein the dialkyl quaternary ammonium compounds are dicetyl dimethylammonium chloride, distearyl dimethylammonium chloride, debehenyl dimethylammonium chloride.

20. A composition according to claim 1 wherein said composition further comprises one or more cosmetically acceptable ingredients, said ingredients being selected from the group consisting of surfactants, polymers, silicones, solvents, oils, preservatives, and fragrances.

21. A composition according to claim 20, wherein the cosmetically acceptable ingredient is a conditioning surfactant selected from the group consisting of Behentrimonium Methosulfate, Behentrimonium Chloride, Cetyl Trimethyl Ammonium Chloride, and the mixtures thereof.

22. A composition for depositing a benefit agent on a negatively-charged substrate comprising:
(a) a positively-charged compound and an HLB of less than about 10; and
(b) a benefit agent dispersed substantially homogeneously therein.

23. A method of depositing a benefit agent on a negatively-charged substrate comprising contacting said negatively-charged substrate with a composition comprising a quaternary ammonium compound according to formula (1) 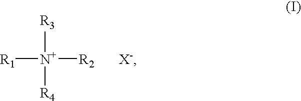
wherein
R₁, R₂, and R₃ are straight or branched carbon chains that may be alkyl or alkenyl groups having from about 8 to about 36 carbon atoms and R₄ is a lower alkyl chain having from about 1 to about 4 carbon atoms or a lower alcohol having from about 1 to about 4 carbon atoms.
R₁ and R₂ may both be identical or different straight or branched alkyl or alkenyl chains having from about 8 to about 36 carbon atoms, and R₃ and R₄, independently of one another, may be identical or different and are lower alkyl chain having from about 1 to about 4 carbon atoms or a lower alcohol having from about 1 to about 4 carbon atoms; and
X— is an anion selected from the group consisting of halogens and oxo acids.

24. A method of making a composition for delivering a benefit agent to an anionic substrate, comprising mixing a cationic quaternary ammonium compounds according to claim 1 with a benefit agents and applying sufficient energy to the combination to form a homogeneous mixture by dispersing the benefit agent uniformly with the cationic quaternary ammonium compound.

25. A composition according to claim 1 wherein R₁, R₂, and R₃ are straight or branched carbon chains that comprising alkyl or alkenyl groups having from about 12 to about 22 carbon atoms.

26. A composition according to claim 1 wherein R₁, R₂, and R₃ are straight or branched carbon chains that comprising alkyl or alkenyl groups having from about 18 to about 22 carbon atoms.
